(19) United States
(12) Patent Application Publication
(10) Pub. No.: US 2017/0167162 A1
(43) Pub. Date: Jun. 15, 2017

(54) Free-Standing Modular Fence System

(71) Applicant: AEMM, LLC, Costa Mesa, CA (US)

(72) Inventor: Michael E. Martin, Santa Ana, CA (US)

(73) Assignee: AEMM, LLC, Costa Mesa, CA (US)

(21) Appl. No.: 15/152,042

(22) Filed: May 11, 2016

Related U.S. Application Data
(60) Provisional application No. 62/265,355, filed on Dec. 9, 2015.

(51) Int. Cl. E04H 17/16; B32B 27/38; B32B 37/12; B32B 21/14; E04H 12/22; B32B 5/18

(52) U.S. Cl. CPC E04H 17/165; E04H 12/2215; E04H 12/2269; B32B 5/18; B32B 37/12; B32B 21/14; B32B 27/38; B32B 2607/00

(57) ABSTRACT

A free-standing fence system includes two or more posts and one or more substantially planar prefabricated panels. Each prefabricated panel is configured to be coupled to two of the posts. Each prefabricated panel comprises a foam core and a first veneer layer. The foam core has a first side and a second side. The first veneer layer is coupled to and substantially covers the entire first side of the foam core. The veneer layer comprises one or more veneer members. Each veneer member includes a decorative layer of a continuous natural stone material and a binding layer coupled to a rear surface of the decorative layer.

### CROSS-REFERENCE TO RELATED APPLICATION(S)

This application claims priority to and the benefit of U.S. Provisional Application No. 62/265,355, filed Dec. 9, 2015, the entire disclosure of which is incorporated herein by reference.

### BACKGROUND

The present disclosure relates to free-standing fence or wall systems, which are supported generally independent of other structures or buildings. Conventional free-standing walls or barriers are constructed using stones, bricks, or blocks, which are individually placed, stacked, and typically mortared to each other. The process of constructing such conventional walls is labor intensive and expensive. It would be advantageous to provide a free-standing fence or wall system that is lighter weight, modularized, and more easily installed, while still providing the appearance of a solid stone wall.

### SUMMARY

A free-standing fence system includes two or more posts and one or more substantially planar prefabricated panels. Each prefabricated panel is configured to be coupled to two of the posts. Each prefabricated panel comprises a foam core and a first veneer layer. The foam core has a first side and a second side. The first veneer layer is coupled to and substantially covers the entire first side of the foam core. The veneer layer comprises one or more veneer members. Each veneer member includes a decorative layer of a continuous natural stone material and a binding layer coupled to a rear surface of the decorative layer.

### BRIEF DESCRIPTION OF THE DRAWINGS

The description herein makes reference to the accompanying drawings, wherein like reference numerals refer to like parts throughout several views, and wherein:

FIG. 1 is a plan view of a free-standing fence system according to an exemplary embodiment;

FIG. 2 is a partial cross-sectional, deconstructed view of the free-standing fence system shown in FIG. 1;

FIG. 3A is a partial cross-sectional view taken along line 3-3 in FIG. 1;

FIG. 3B is an alternative partial cross-sectional view to FIG. 3A;

FIG. 4A is a cross-sectional view taken along line 4A-4A in FIG. 1;

FIG. 4B is a zoomed view of box 4B in FIG. 4A;

FIG. 4C is an alternative cross-sectional view of a panel according to an exemplary embodiment;

FIG. 5 is a cross-sectional view of a veneer layer of a panel according to an exemplary embodiment;

FIG. 5A is a partial cross-sectional, deconstructed view a panel of the free-standing fence system according to an exemplary embodiment;

FIG. 5B is a partial cross-sectional, deconstructed view a panel of the free-standing fence system according to another exemplary embodiment;

FIG. 5C is a partial cross-sectional, deconstructed view a panel of the free-standing fence system according to another exemplary embodiment;

FIG. 6A is a cross-sectional view of an intermediate post of the free-standing fence system according to an exemplary embodiment;

FIG. 6B is a cross-sectional view of an end post of the free-standing fence system according to an exemplary embodiment.

FIG. 7 is a plan view of a free-standing fence system according to another embodiment;

FIG. 7A is a cross-sectional view taken along line 7A-7A in FIG. 7;

FIG. 7B is a cross-sectional view taken along line 7B-7B in FIG. 7;

FIG. 8A is a cross-sectional view of a post of the freestanding fence system shown in FIG. 7;

FIG. 8B is a cross-sectional view of an upper cross member of the freestanding fence system shown in FIG. 7;

FIG. 8C is a cross-sectional view of a lower cross member of the freestanding fence system shown in FIG. 7; and

FIG. 8D is a cross-sectional view of an intermediate cross member of the freestanding fence system shown in FIG. 7.

### DETAILED DESCRIPTION

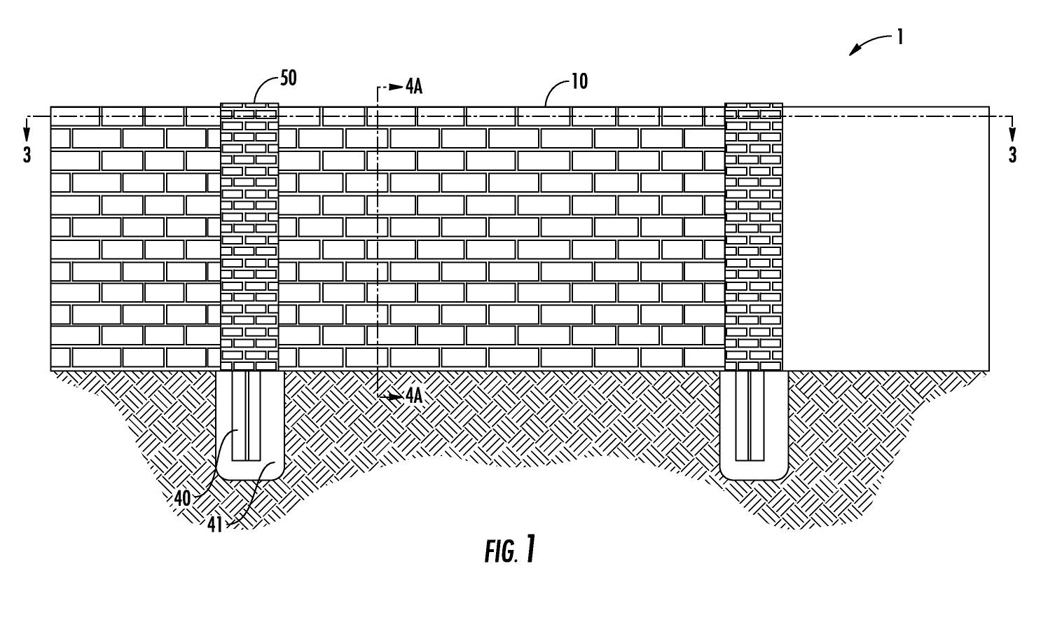

FIG. 1 depicts a free-standing fence or wall system 1. The free-standing fence system 1 is provides an opaque, decorative barrier, which may be installed independent of other structures. The free-standing fence system 1 generally includes panels or panel assemblies 10, posts 40, and covers 50. The posts 40 are configured to be easily set in the ground and to receive the panels 10 therebetween. The panels 10 are prefabricated, lightweight, composite panels or planar members having a decorative material on one or both sides thereof (e.g., natural stone, stucco, or brick). The covers 50 are lightweight composite panels or members having a decorative material, which are configured to cover the joints at which the panels 10 are coupled to the posts 40.

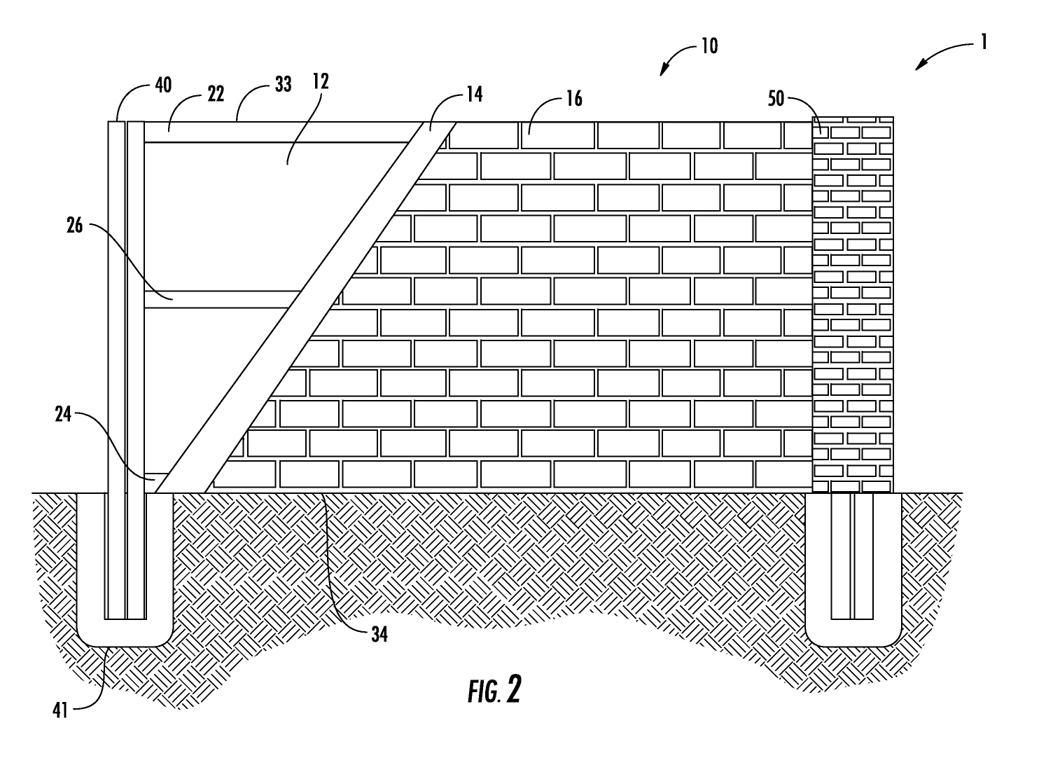

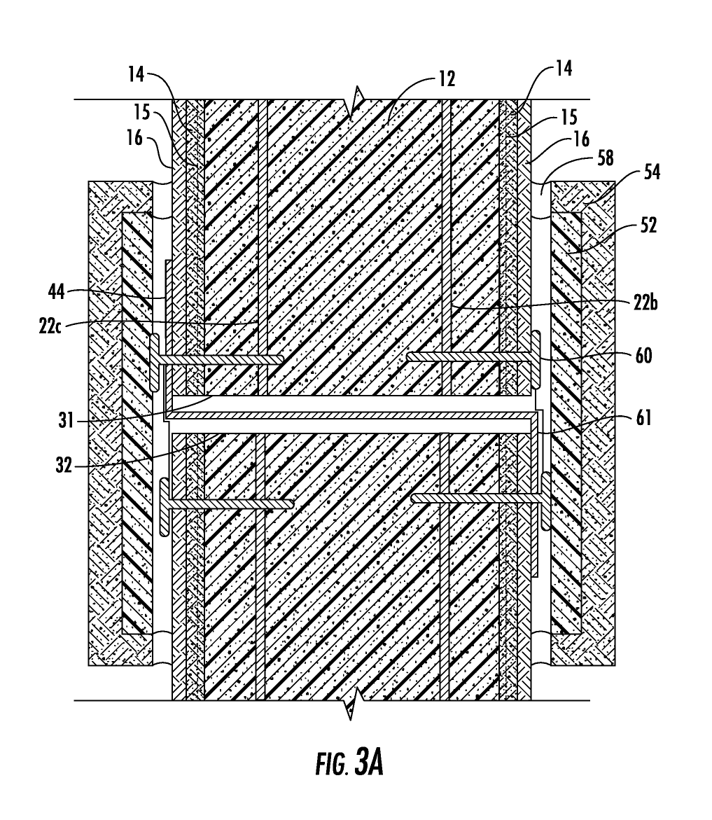

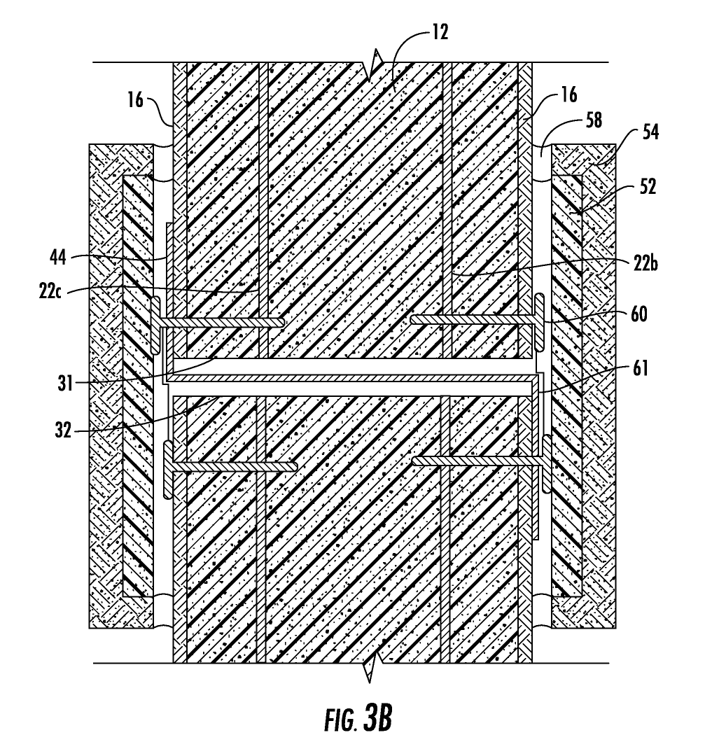

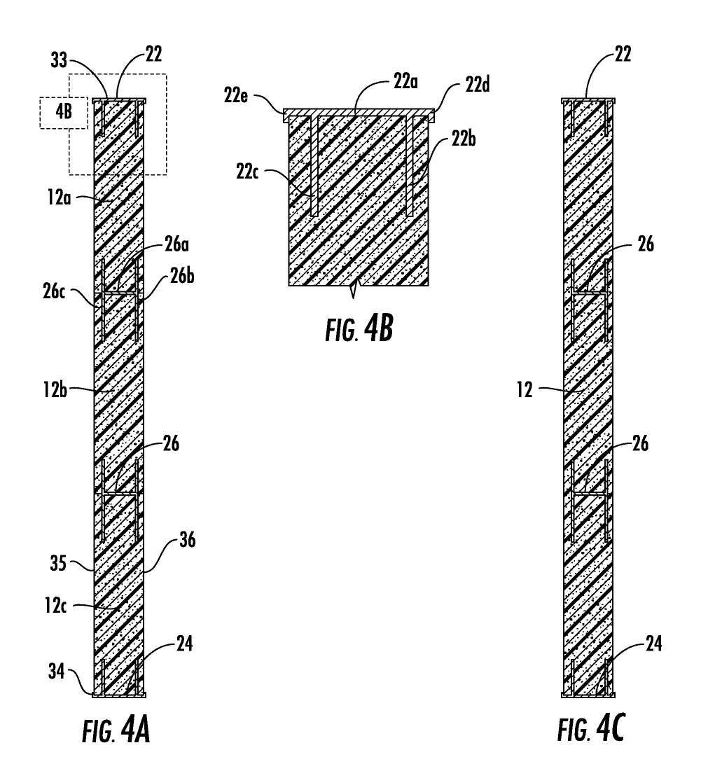

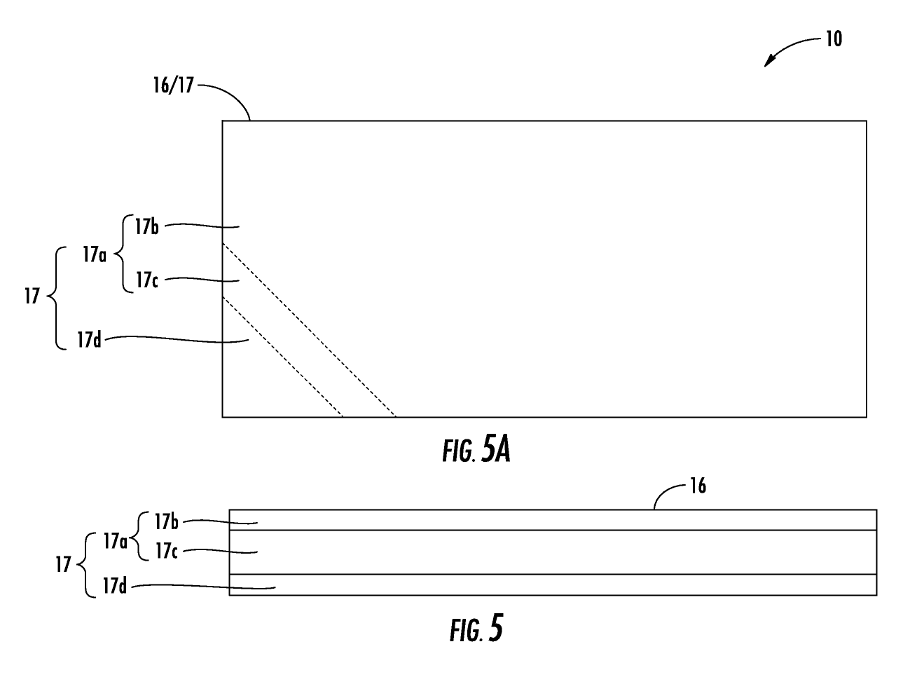

As shown in FIGS. 1 and 2, the panels 10 are generally planar, composite layered, decorative panels that are configured to be mounted or connected to the posts 40. As best shown in FIGS. 2 and 3, each panel 10 generally includes, in a layered relationship moving from the interior to the exterior, a core 12, a base layer 14 on each side of the core 12, and a veneer layer 16 on each side of the panel base layer 14. As best shown in FIGS. 2, and 4A-4C, each panel 10 further includes an upper structural member 22 and a bottom structural member 24, and may also include one or more intermediate structural members 26.

As used herein with respect to each panel 10, the term “side” generally refers to the largest planar surfaces of each panel 10 or each layer thereof, the term “end” refers the vertical surfaces extending between the sides, and the terms “top” and “bottom” refer to the upper and lower surfaces, respectively, extending between the sides. Each panel 10 has a width extending between ends 31, 32, a height extending between a top 33 and a bottom 34, and a thickness extending between decorative sides 35, 36, which is substantially smaller than both the width and height. For example, each panel 10 may have a width of eight feet, one of various different incremental heights (e.g., 2 feet, 4 feet, 6 feet), and a thickness of approximately 3.0 inches (e.g., between approximately 2.5 and 5.0 inches). According to other exemplary embodiments, each panel 10 may have a different width, height, and/or thickness. Additionally, as discussed below, each panel 10 may be configured to be cut to a desired length, and multiple panels 10 may be stacked to form a wall having a greater overall height than each individual panel 10.

As shown in FIGS. 2, 3, and 4A-4C, the core 12 is the innermost layer of the panel 10 and provides a lightweight substrate having a generally planar surface to which the base layer 14 is coupled. The core 12 forms a majority of the thickness of the panel 10, such as greater than approximately ⅔ the thickness (e.g., greater than 70%, or 80% of thickness; 2.5 inches of a panel 10 having a thickness of approximately 3.0 inches, etc.). The core 12 may be one or more inner core members or panels made from a rigid foam material (e.g., expanded polystyrene (EPS), extruded polystyrene (XPS), polyisocyanurate, or polyurethane). In panels 10 having a core 12 with multiple inner core members 12a, 12b, 12c, the inner core members 12a, 12b, 12c may, in some but not all embodiments, be coupled together by intermediate structural members 26 as will be discussed in further detail below (FIG. 4A). Alternatively, structural members 26 may be incorporated into the core 12 by forming or curing the foam around such structural members 26 (FIG. 4C). It should be noted that in FIGS. 4A-4C, the base layers 14 and the veneer layers 16 are collectively depicted as vertical lines on either side of the core 12.

With references to FIGS. 2 and 3A, the base layers 14 are continuous, rigid coating layers coupled to one or, preferably both, sides of the core 12. The base layers 14 cover one or both sides of the core 12 substantially in their entirety. Each base layer 14 strengthens the foam core 12, while providing a moisture barrier and a surface to which the veneer layer 16 is coupled. The base layer 14 is a cementitious material cured to the core 12, which may additionally be polymer-modified and/or fiber-reinforced (e.g., a portland cement material comprising sand/silica/quartz, portland cement, lime, polymer modifiers, and/or reinforcing fibers), and may also be particularly suited for use with the foam material of the core 12 (e.g., polystyrene). For example, the cementitious material of the base layer 14 may be QUIKRETE® Foam Coating (Product No. 1219), or other similar material, which is applied and cured to the core 12. Each base layer 14 may additionally include a mesh material 15 (e.g., fiberglass mesh) set and cured therein to further strengthen the base layer 14. The base layer 14 may have a nominal thickness of between approximately ⅛ and ½ inch (e.g., approximately ⅛ to ¼ inch), or other thickness as may be required by the manufacturer of the cementitious material or desired for a particular application. The base layer 14 is relatively thin as compared to the core 12 (e.g., less than 10% of the thickness of the core 12, such approximately 5% or less). It should also be noted that the base layer 14 may be generally uniform but may vary (e.g., based on the surface of the core 12). Alternatively, the panel 10 may not include a base layer 14 (see FIG. 3B).

With reference to FIGS. 2, 3A, 3B, and 5-5C, the veneer layers 16 are thin outer layers coupled to the base layer 14 on one or both sides of each panel 10 to provide the appearance of a solid wall (e.g., stacked stone wall, concrete wall with stucco finish, or solid brick wall), while providing each panel 10 with assembly advantages (e.g., light weight and modular/panelized installation) over such types of solid walls, as well as structural advantages. In alternative embodiments with no base layer, the veneer layer 16 may be coupled directly to the core 12 as discussed below (FIG. 3B).

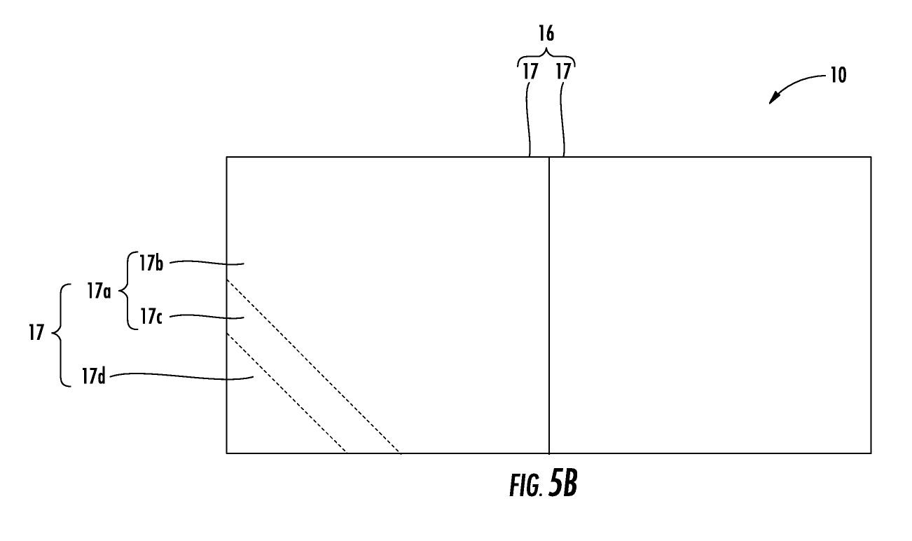

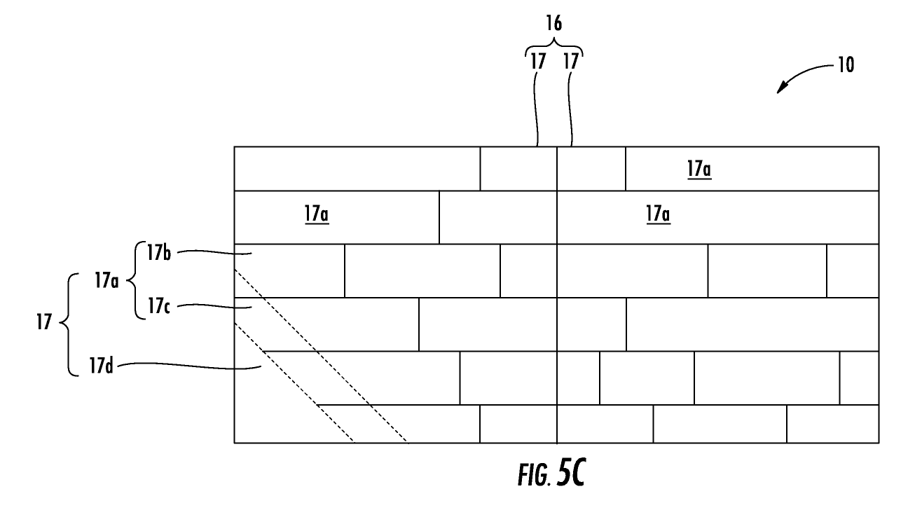

Each veneer layer 16 comprises one or more veneer sheets or assemblies 17, which are coupled to the base layer 14 (or the core 12), so as to collectively substantially cover one or both sides of each panel 10 in their entirety. In embodiments with only one veneer assembly 17, the veneer assembly 17 continuously covers substantially the entire surface of the panel 10 (FIG. 5A). In embodiments with multiple veneer assemblies 17 (FIGS. 5B and 5C), the veneer assemblies 17 are positioned adjacent each other in an abutting relationship (i.e., contact edges of adjacent veneer assemblies 17), or to otherwise form a gap or joint therebetween (e.g., filled with grout, adhesive, or other filler material).

Each veneer assembly 17 assembly includes one or more veneer pieces or members 17a, which are coupled to each other to form the veneer assembly 17. Each veneer member 17a generally includes a decorative layer 17b and a binding layer 17c. In embodiments where each veneer assembly 17 includes only one veneer member 17a (FIGS. 5A and 5B), the veneer member 17a forms the entire outer surface of the veneer assembly 17. In embodiments where the veneer assembly 17 includes multiple veneer members 17a (FIG. 5C), the veneer members 17a are coupled to each other from rear surfaces thereof (as discussed below), while being positioned adjacent each other in an abutting relationship, or to otherwise form a joint or gap therebetween (e.g., filled with grout, adhesive, or other filler material).

Each veneer member 17a includes a decorative layer 17b and a binding layer 17c (e.g., adhesive or epoxy layer). The decorative layer 17b is a thin layer of continuous natural stone, which has been extracted from a source natural stone formation (e.g., a slab) as a continuous layer and forms the forward or outer surface of the panel 10. The binding layer 17c is coupled to and covers an entire rear or inner surface of the decorative layer 17b and is formed from an epoxy or other polymer adhesive. The binding layer 17c (e.g., the epoxy) may impregnate and cure at least partially within the material (e.g., natural stone) of the decorative layer 17b. The binding layer 17c functions to bind together the decorative layer 17b to maintain the decorative layer 17b with its original appearance or configuration when part of the natural stone formation (i.e., maintaining individual areas or components of the decorative layer 17b in their original, lateral relationships). Each veneer member 17a may have a nominal thickness of between approximately 1.0 to 4.0 mm. Relative to the core 12, each veneer member 17a is relatively thin (e.g., less than approximately 15% of the thickness of the core, or more preferably less than approximately 10%). The decorative layer 17b forms a minority of the thickness (e.g., approximately 0.4 to 1.25 mm, or approximately ⅓ or less of the decorative layer 17a thickness), while the binding layer 17c forms a majority of the thickness (e.g., approximately 0.8 mm to 3.5 mm, or approximately ⅔ of more of the decorative layer 17a thickness). Relative to the thickness of the core 12, the decorative layer 17b is relatively thin (e.g., between approximately 0.1 and 5% of the thickness of the core 12, or more preferably less than approximately 2.5% It should be noted that the aforementioned thicknesses are nominal, while the decorative layer 17b (especially if using a natural stone material) and/or binding layer 17c may vary in thickness, for example, by having localized roughness, undulations, or projections. According to other exemplary embodiments, the veneer member 17a, including the decorative layer 17b and the binding layer 17c thereof, may have different thicknesses.

The binding layer 17c is flexible and generally elastic, thereby allowing each veneer member 17a to bend, while still maintaining the decorative layer 17b with its original appearance, albeit forming a curved surface. For example, the binding layer 17c may allow for the veneer member 17a to bend to a radius of approximately twenty inches, and return to its original configuration without any noticeable visual change to an observer. As part of each panel 10, this resilient flexibility of each veneer member 17b advantageously provides that the appearance of each panel 10 may be maintained with dynamic flexing of the panel 10 (e.g., with wind loading, freeze/thaw cycles, and other forces) or static bending, either of which might otherwise cause different decorative materials (e.g., rigid stone or veneer) to crack or shift and change the appearance of the panel 10. The resilient flexibility of each veneer member 17b, thereby, allows the panel 10 to be constructed with different structural properties and features (e.g., lighter weight, less rigidity, etc.) from those required for other decorative materials, which may provide various other advantages (e.g., modularity, assembly, transport, etc.).

Each veneer assembly 17 may further include a backing or adhesive layer 17d. The backing layer 17d is an intermediate layer, which couples the veneer assembly 17 to the underlying layer of the panel 10 (e.g., core 12, as shown in FIG. 3B, or base layer 14, as shown in FIG. 3A). In embodiments wherein the veneer assembly 17 includes multiple veneer members 17a, the backing layer 17d further functions to hold each veneer member 17a in a predetermined spatial relationship (e.g., abutting relationship, or for a stacked stone appearance) by coupling to a rear surface of each veneer member 17a (i.e., the binding layer 17c). In other embodiments, each veneer assembly 17 does not include the backing layer 17d in which case the binding layer 17c is coupled directly to the base layer 14 (or the core 12) with an adhesive (e.g., a curable adhesive or a tap adhesive).

According to an exemplary embodiment, the backing layer 17d is an adhesive tape product having a flexible polymer sheet material (e.g., a foam or membrane), which covers an entire rear surface of the veneer member 17a. The backing layer 17d includes or has applied thereto an adhesive (not shown) spread continuously or intermittently on a forward surface thereof, which is suitable for adhering the polymer sheet of the backing layer 17d to the binding layer 17c of the one or more veneer members 17b. The backing layer 17d may further include or have applied thereto an adhesive (not shown) spread continuously or intermittently on a rearward surface thereof, which is suitable for adhering to the underlying layer of the panel 10 (e.g., the core 12 or the base layer 14). The backing layer 17d may, for example, be a single- or double-sided 3M™ VHB™ adhesive tape product. With the adhesives bonding continuously to the surfaces of the base layer 14 (or the core 12 if no base layer 14 is included) and the veneer assemblies 10, the veneer assemblies 17 form a substantially continuous rigid outer shell (e.g., by way of the binding layer 17c and/or the decorative layer 17b) that adds bending rigidity to the panel 10, especially when coupled to both backing layers 17d (or to each side of the core 12).

According to other exemplary embodiments, the backing layer 17d may be a woven, mesh, or otherwise porous material (e.g., fiberglass or other fabric) coupled to the binding layer 17c with an intermediate adhesive (not shown) (e.g., epoxy cured separately from the adhesive layer 17b, glue, or other suitable adhesive), which may be spread intermittently or continuously between the substrate layer 17c and adhesive layer 17b of each of the one or more stone pieces of the decorative layer 17a.

It should be noted that the thickness of the veneer member 17a, including the thicknesses of the decorative layer 17b and binding layer 17c, are nominal thickness and may vary throughout a given veneer member 17a, especially considering where the decorative layer 17b is natural stone. This may result in the visible outer surface of the decorative layer 17b and/or the rear surface (i.e., facing the core 12) of the binding layer 17c having several localized undulations (e.g., protrusions, irregularities, roughness, etc.) that extend rearward in a generally normal direction relative to the visible surface of the decorative layer 17b. Accordingly, it may be advantageous to adhere the binding layer 17c, or other uneven rear surface (e.g., the backing layer 17d) of the veneer member 17a, to the base layer 14 or to the core 12 with a compliant material. The compliant material may be a curable adhesive or include compliant intermediate layer that receives or accommodate the localized undulations to still allow for a substantially continuous bond across the entire surface of the binding layer 17c. For example, a curable adhesive, applied with sufficient thickness, receives and cures to the localized undulations, as well as the surrounding areas of the binding layer 17c. Similarly, the compliant material may include a compliant layer of sufficient thickness and having a thin adhesive applied thereto (e.g., such as foam, for example, of a single- or double-sided tape), allows the localized undulations to press/deform the compliant layer, while the thin adhesive bonds to the rough surface and/or localized undulations, as well as the surrounding areas of the binding layer 17. The compliant intermediate layer may be formed by the backing layer 17d. In contrast, if the localized undulations 17c were instead applied directly to a non-compliant surface (e.g., the base layer 14 of a cured cementitious material), bonding to the binding layer 17c in regions having localized undulations may be limited due to point contact.

Additionally, any adhesive for coupling the veneer assembly 17a to the panel 10 must account for the differing properties of the base layer 14 (e.g., being cementitious) or the core 12 (e.g., rigid foam; if no base layer 14 is included) from the binding layer 17c (e.g., epoxy). For example, a curable adhesive must be capable of bonding to both the material of the base layer 14 (or core 12) and that of the binding layer 17c. Alternatively, if an intermediate layer is provided (e.g., such as the binding layer 17d, or other compliant layer referenced above, or tape), then the thin adhesive materials on each side of the intermediate layers may be differently suited for bonding to the different materials, or be the same material suited for the different materials of the base layer 14 (or core 12) and the binding layer 17c.

According to other exemplary embodiments, one, more, or all of the inner layers of the veneer assembly 17 may be omitted or added. For example, the binding layer 17c may be coupled directly to the core 12 or base layer 14 with a suitable adhesive (i.e., omitting the backing layer 17d, as referenced above), or other or different intermediate layers with suitable adhesives may be used (e.g., a woven, mesh, or other porous material being disposed between the backing layer 17d and the binding layer 17c of the veneer member 17a). According to still other exemplary embodiments the veneer layer 16 may be provided as stucco or other curable material, which is applied directly to the base layer 14 of the panel 10.

With reference to FIGS. 2, and 4A-4C, each panel 10 further includes an upper structural member 22 (e.g., top cap) and a bottom structural member 24 (e.g., bottom cap or base), and may also include one or more intermediate structural members 26. The structural members 26 are generally rigid members (e.g., 18 gauge aluminum or galvanized steel), which strengthen each panel 20 to prevent or limit downward sagging and/or lateral bowing of the panel 20 across its span between posts 40, which might otherwise cause cracking of the veneer layer 16 or cause other visual distortions to the panel 20.

The upper structural member 22 is coupled to the core 12 at the top 33 of the panel 10 and spans generally the entire width W between the ends 31, 32 of the panel 10. The upper structural member 22 has a generally constant cross-section with a laterally extending upper segment or web 22a and one or more central, spaced-apart segments or flanges 22b, 22c that extend downward from the upper segment 22a (e.g., at generally perpendicular angles). The upper segment 22a spans a lateral distance so as to cover upper edges of the core 12, base layer 14, and veneer layer 16. A lower surface of the lateral segment 22a is positioned against or proximate to top surfaces or edges of the core 12, base layers 14, and veneer layers 16, while the downwardly protruding segments 22b, 22c extend into receiving slots in an interior portion of the core 12. Mating surfaces of the structural member 22 and the core 12 are coupled to each other, for example, with an adhesive, or alternatively with the foam of the core 12 curing directly to the upper structural member 22.

The upper structural member 22 may additionally include two outer segments or flanges 22d, 22e that extend downwardly from or proximate to outer edges of the laterally extending segment 22a a relatively short height as compared to the central segments 22b, 22c. The two outer segments 22d, 22e extend downward so as to cover horizontal joint or gap between the upper edge of the veneer layer 16 and lower surface of the upper segment 22a, and may also form a drip edge to prevent water intrusion into the panel 20 (e.g., through surface tension). The two outer segments 22d, 22e are spaced apart a distance approximately equal to the thickness of the panel 10 (i.e., between outer surfaces of opposite veneer layers 16) plus any further distance required to form the drip edge and/or account for any variation in the thickness of the panel 10 (e.g., variation in thicknesses of the core 12, base layer 14, veneer layer 16, and any adhesives therebetween).

The lower structural member 24 is configured and coupled to the panel 10 in substantially similar manners as the upper structural member 22, albeit with central segments 24b, 24c and outer segments 24d, 24e extending upward from a central segment 24a into the core 12 and adjacent the veneer layer 16, respectively. The lower structural member 24 additionally includes apertures (e.g., weep holes; not shown) extending through the central segment 24a (e.g., between the central segments 24b, 24c and outer segments 24d, 24e) to provide a leak path for water to exit the lower structural member 24.

The one or more intermediate structural members 26, if utilized, are positioned at an intermediate height between the top 33 and bottom 34 of the panel 10 and span generally the entire width between the ends 31, 32 of the panel. Each intermediate structural member 26 has a generally constant H-shaped cross-section with a central web or segment 26a and two side segments or legs 26b, 26c extending upward and downward from edges of the central segment 26a. In one embodiment shown in FIG. 4A, the core 12 is provided as multiple upper, middle, and lower foam panels 12A, 12B, and 12C, which are coupled to each other with the intermediate structural members 26 and a suitable adhesive. For example, an upper surface of the central segment 26a of an upper intermediate structural member 26 is positioned against a lower surface of the upper foam panel 12a, with upper portions of the two side segments 26b, 26c extending upward into receiving slots in an interior of the panel 12a. A lower surface of the central segment 26a is positioned against an upper surface of the middle foam panel 12b, with lower portions of the two side segments 26b, 26c extending downward into receiving slots in an interior of the panel 12b. The lower intermediate structural member 26 is similarly coupled to the middle foam panel 12b and lower foam panel 12c. The multiple foam panels 12a, 12b, etc. may be similarly configured, for example, having a common height and having common features (e.g., slots, as discussed below) for coupling to the different structural members 22, 24, and 26, such that common foam panel design may serve as any of the upper, middle, lower, or only foam panel of the core 12.

According to another embodiment shown in FIG. 4C, the intermediate structural member 26 may be provided integrally with a single foam panel having foam cured directly to the intermediate structural members 26. According to still other exemplary embodiments, intermediate structural members 26 having different shapes are contemplated that may couple multiple foam panels to each other (e.g., Z-shaped, cross-shaped, I-shaped) or that are provided integrally within a single foam panel (e.g., Z-shaped, cross-shaped, I-shaped, C-shaped, T-shaped, etc.).

Each intermediate structural member 26 has a width (e.g., between approximately 2.0 and 3.0 inches) that is less than a thickness of the core 12 (e.g., between approximately 3.0 and 4.0 inches), so as to be encased by the foam of the core 12 (i.e., of a single foam panel, or multiple foam panels 12a, 12b, etc.) with at least an outer portion of the core 12 (e.g., between approximately 0.5 and 1.0 inches) being arranged between the intermediate structural member 26 and the base layer 14 or veneer layer 16 coupled thereto. By encasing the intermediate structural member 26, the base layer 14 may be applied to the surface of a single type of material with consistent adherence properties. Furthermore, the outer portion of the core 12 insulates the intermediate structural member 26, which is made from a heat conductive material and might otherwise transfer heat between the two sides of the panel 10 (e.g., between sunny and shaded sides), which may cause localized differences of appearance due to temperature differences in regions adjacent the structural member 26 (e.g., from condensation forming on the veneer layer 16).

As shown in FIGS. 1, 2, 6A, and 6B, the posts 40 are structural members configured to mount the panels 10 to the ground and maintain the panels 10 in a fixed vertical orientation by resisting horizontal forces (e.g., wind against the panels 10). Each post 40 is a continuous member and may, for example, be 11 gauge steel, but may have different gauges or thickness or may be made from other materials (e.g., aluminum, galvanized steel, etc.). The posts 40 are set into the ground, for example, using concrete 41 in holes extending below the ground surface to the frost line or other sufficient depth (e.g., 42 inches) to prevent horizontal movement (e.g., tipping) of the posts 40.

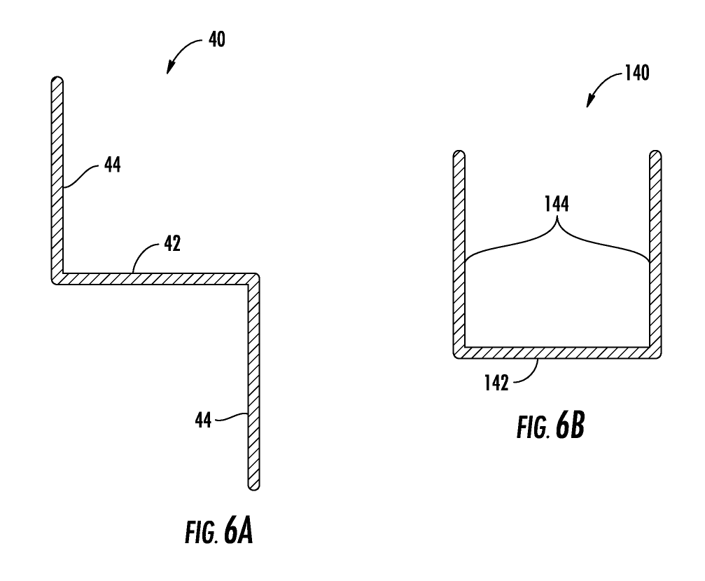

The posts 40 may be configured either as intermediate posts 40 (FIGS. 1, 3, 6A), which are configured to be positioned between two panels 10 on either side thereof, while posts may also be configured as end posts 110 (FIG. 6B). When configured as an intermediate post, the post 40 has a substantially Z-shaped horizontal cross-section as shown in FIGS. 3A and 5. The post 40 generally includes a central segment or web 42 and two lateral segments or legs 44 that extend from opposite ends of the central segment 42 at approximately 90 degrees in opposite directions from each other. When configured as an end post, the post 140 may have a U-shaped horizontal cross section as shown in FIG. 6B. The post 140 generally includes a central segment or web 142 and two lateral segments or legs 144 that extend from opposite ends of the central segment 142 at approximately 90 degrees in the same direction as each other.

By configuring each intermediate post 40 with lateral segments 44 extending in opposite directions from the central segment 42 (i.e., with a Z-shaped cross-section), the posts 40 allow for simplified installation of the panels 10 for both generally straight portions and corner sections of the fence system 1. In particular, the Z-shaped posts allow for horizontal placement of the panels 10 adjacent the lateral segments 44 of the post 40, as opposed to vertical insertion if the panels 10 were instead received in U-shaped channels of a post.

For example, if the lateral segments 44 of two posts 40 are positioned on a common side of the panel 10, the panel 10 may simply be oriented with the sides 35, 36 and ends 31, 32 thereof extending substantially vertically (i.e., a vertical orientation) and then moved laterally such that one of the decorative sides 35, 36 (i.e., having the veneer layer 16) or an intermediate material (e.g., a protective material) is placed against the lateral segments 44 of the two posts 40 with opposite ends 31, 32 of the panel 10 being positioned adjacent the central segment 42 of the two posts 40. Alternatively, if the lateral segments 44 of two posts 40 are positioned on opposite decorative sides 35, 36 of the panel 10, the panel 10 may be moved into the vertical orientation, moved laterally to a position between the two posts 40, and pivoted for the each decorative side 35, 36 to engage the lateral segment 44 of one of the posts 40 with the ends 31, 32 of the panel 10 being positions adjacent the central segments 42 of the two posts 40. The panel 10 may then be fastened to the lateral segment 44 of the post 40 (as described below).

For perpendicular corners (e.g., where adjacent panels 10 form an angle of approximately 90), one lateral segment 44 of the post 40 is positioned toward the outermost portion of the intersection, with a decorative 35 and an end 31 of one panel 10 being positioned against the central segment 42 and lateral segment 44 and, respectively of the post 40. For non-perpendicular corners, the panels 10 may be coupled to the post 40 in other manners as may be deemed appropriate and/or may be field cut (e.g., using a circular saw with a diamond- or carbide-tipped blade of sufficient size to extend entirely through the thickness of the panel 10) such that the surface of the ends 31, 32 are not perpendicular to the decorative sides 35, 36. The panel 10 may also be cut to an appropriate or desired length.

To provide fence systems 1 with greater height, panels 10 may be provided with different heights (as described above) and may be stacked on top of each other with the lower structural member 24 of an upper panel 10 resting on the upper structural member 22 of a lower panel 10. To prevent unequal bowing between the stacked panels 10, the lower structural member 24 of the upper panel 10 may be coupled to the upper structural member 22 of the lower panel 10, for example, using mechanical fasteners and/or a suitable adhesive. To account for varying slopes, the panel 10 (or a bottom panel 10) may be embedded into the ground, thus providing a fence system 1 that extends continuously upward from the ground across varying slopes.

To attach the panel 10 to each post 40, fasteners 60 extend through the lateral segment 44 of the post 40 through the veneer layer 16, base layer 14, core 12, and into each structural member (e.g., at least one of the central segments 22b, 22c of the upper structural member 22 as shown in FIGS. 3A and 3B, at least one of the central segments 24b, 24c of the lower structural member 24 (not shown), and at least one of side segments 26b, 26c of any included intermediate structural members 26 (not shown)). In this manner, a structural, rigid connection is formed between the post 40 and the structural members 22, 24, 26 of the panel 10, the post 40 thereby both supporting the panel 10 and also further strengthening the panel 10 (e.g., preventing bending about a horizontal axis). The fasteners 60 extend through apertures in the post 40 and structural member. While the apertures may be prefabricated, field applications may require cutting panels 10 to length and mounting posts 40 at different heights (e.g., due to sloping ground), such that apertures may instead be formed in the field. For example, the panel 10 may be temporarily mounted or supported against the post 40, while apertures are drilled through the post 40 and panel 10, including each structural member (e.g., upper structural member 22). The fasteners 60 (e.g., threaded fasteners that thread into material surrounding the apertures) are then inserted into the apertures for coupling the panel 10 to the post 40 after which the temporary mount or supports may be removed. While the fasteners 60 are depicted as extending only partly into the panel 10, the fasteners 60 may extend entirely through the panel 10 (e.g., a bolt mating to a nut on the opposite side surface 35, 36 of the panel 10). The fasteners 60 of two adjacent panels may additionally extend through a retaining member 61 positioned against outer surface of the lateral segment 44 of the post 40 coupled to one panel 10 and against the decorative side 35 of another panel 10. The retaining member 61 is made of a generally rigid material (e.g., steel, galvanized steel, or aluminum) and functions to retain the second side 36 of the adjacent panel 10 and prevent rotation of the panel 10 relative to the post 40.

As shown in FIGS. 1-3, covers 50 are each configured to couple to adjacent panels 10 to hide the joints between the adjacent panels 10 and the post 40 therebetween. Each cover 50 includes a foam core 52 (similar to the core 12 of the panel 10), a base layer 54 (similar to the base layer 14 of the panel 10) surrounding three or more sides of the core 52, and may further include a decorative or veneer layer (not shown; similar to the veneer layer 16 of the panel 10). Alternatively, the veneer layer 16 may be coupled directly to the core 52. Each vertical edge of the cover 50 facing the panel 10 is coupled to the panel 10, for example, using grout 58, or another suitable adhesive material. For corner joints of various angles, covers 50 may be trimmed and/or coupled to each other to form inside and/or outside corner covers. Each joint between one or more panels 10, post 40, and covers 50 may further be covered, for example, with a top cap stone to prevent water and debris from entering the joint.

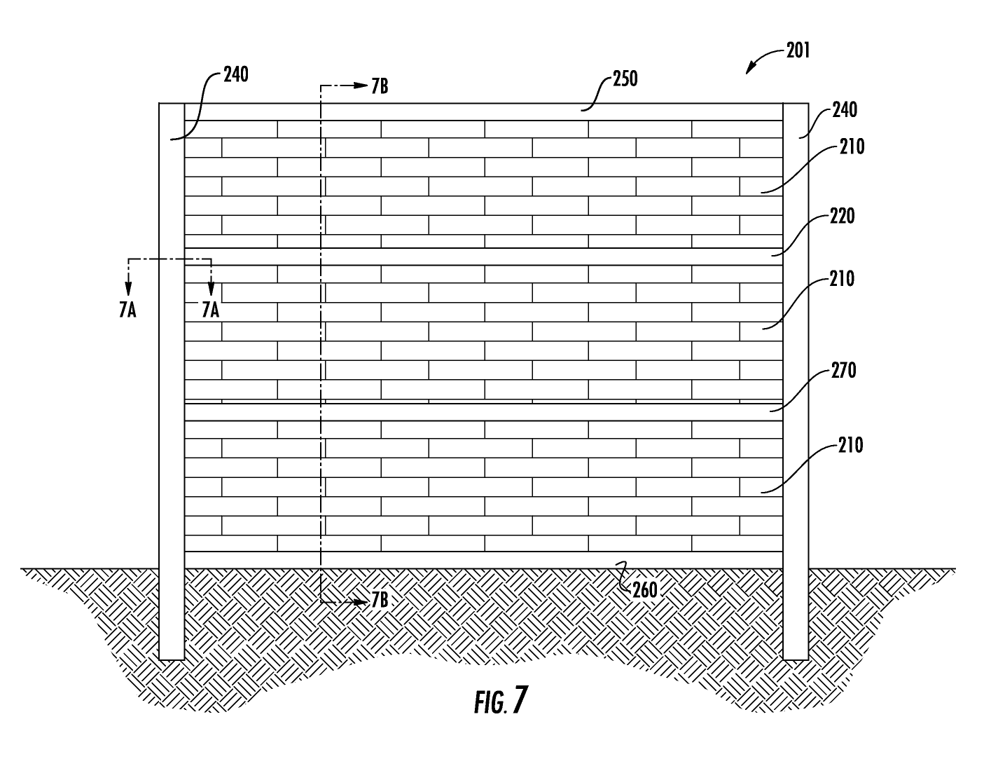

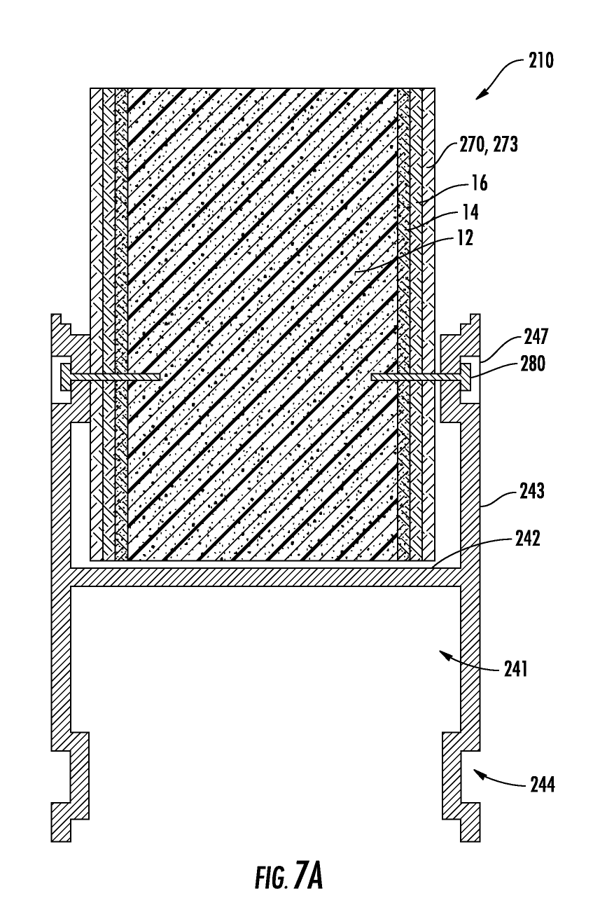

As shown in FIG. 7, according to another exemplary embodiment, a freestanding fence system 201 includes one or more panels 210, two or more posts 240, one or more upper cross members 250, and one or more lower cross members 260. The fence system 201 may also include one or more intermediate cross members 270 depending on the number of panels 210. Each panel 210 spans between and is coupled to two of the posts 240 to be supported thereby, while the cross members 250, 260, 270 also span between and are coupled to two of the posts 240, so as to support and/or prevent bending of the panels 210.

Each panel 210 is configured in one of the layered manners described above for panels 10 (e.g., refer to discussion of the core 12, the decorative layer 16 of veneer assemblies 17, and in some embodiments, the base layer 14). In preferred embodiments, each panel 210 does not include structural members incorporated therewith (e.g., upper, lower, and intermediate structural members 22, 24, 26). Instead, the panels 210 are engaged and/or are supported the upper, lower, and intermediate cross members 250, 260, 270, which are provided separately from the panels 210. That is, the cross members 250, 260, 270 are not part of the modular panel 210. The panels 210 may be provided in a standard size, such as with a common height (e.g., approximately two feet) and a common width (e.g., eight feet), which is easily maneuverable by one or more people, and which may be cut to size by an end user for a particular application. According to other embodiments, the panels 210 may, however, still include one or more of the upper, lower, and/or intermediate structural members 22, 24, 26.

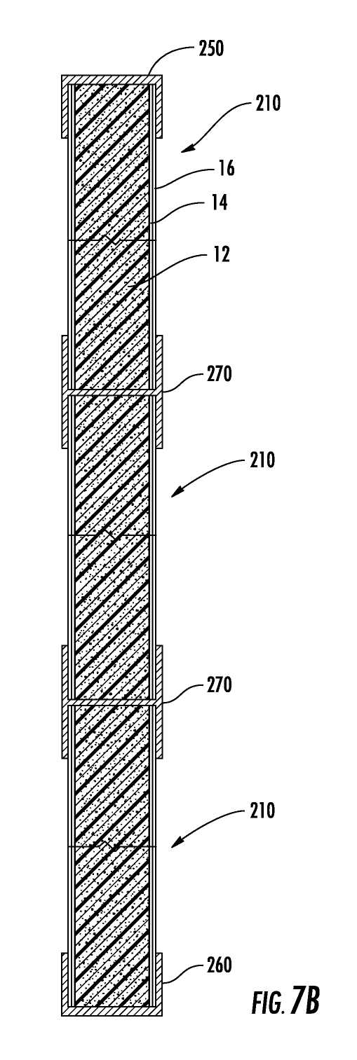

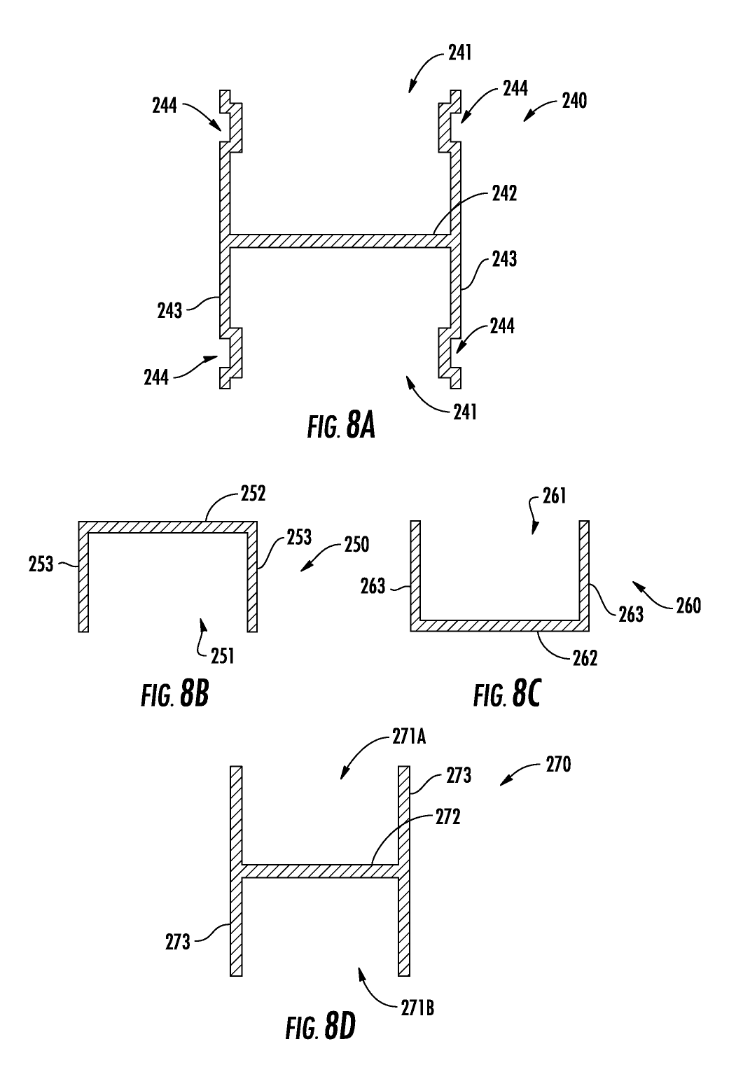

As shown in FIG. 7A and 8A, each post 240 has a generally H-shaped cross-section that defines recesses 241, which are configured to receive ends of the panels 210 and the cross members 250, 260, 270 therein. The post 240 includes a central segment 242 (e.g., a web) and two outer segments 243 (e.g., flange, or leg) that are spaced apart by the central segment 242. The outer segments 243 extend substantially parallel with each other, so as to define the recesses 241 on either side of the central segment 242. Each outer segment 243 may also include or form outer channels 244 on one or both sides of the web 242, which may receive fasteners (e.g., screws, bolts, etc.) for coupling the panels 210 and/or the cross members 250, 260, 270 to the post 240. A trim cover 247 may also be inserted into the outer channels 244 for covering the fasteners 280 (e.g., threaded screws or bolts). To form the outer channels 244, the outer segments 243 may protrude into the recesses 241.

The outer segments 243 of the post 240 are spaced apart a distance that accommodates receipt of the panels 210 and cross members 250, 260, 270 therein (e.g., between the protrusions forming the channels 244). For example, the outer segments 243 may be spaced apart a distance or gap that is slightly greater than outer widths of the cross members 250, 260, 270 (e.g., by approximately one millimeter). According to some embodiments, this small gap allows the inner surfaces of the outer segments 243 to be drawn into engagement and be maintained in contact with outer surfaces of cross-members 250, 260, 270 (e.g., with the threaded fasteners 280), such that friction therebetween, in addition to the shear strength of the threaded fasteners 280, maintains the cross-members 250, 260, 270 at a constant height.

As shown in FIGS. 7B and 8B, the upper cross member 250 has a U-shaped cross section that defines a recess 251 configured to receive an upper end of the panel 210 therein. The upper cross member 250 includes a central segment 252 (e.g., a web) and two outer segments 253 (e.g., flange, or leg) that are spaced apart by the central segment 252 and extend downward therefrom in parallel. By receiving the upper end of the panel 210 in the recess 251, the upper cross member 250 may help prevent bending of the panel 210 in a horizontal direction. As referenced above, the upper cross member 250 has a nominal outer width, formed by the outer segments 253, that is slightly less than the inner width of the recess 241 of the post 240 (e.g., by one millimeter), such that the upper cross member 250 may be received within the recess 241 of the post 240 and be coupled to the post 240 with fasteners. The upper cross members 250 may be provided with a common length (e.g., eight feet) that corresponds to the length of the panel 210, such that each upper cross member 250 spans the distance between two posts 250 to be inserted into the recesses 243 to be supported thereby.

As shown in FIGS. 7B and 8C, the lower cross member 260 is configured similar to the upper cross member 250, but receives a lower end of the panel 210 in a recess 261, thereof. The lower cross member 260 includes a central segment 262 (e.g., a web) and two outer segments 263 (e.g., flange or leg) that are spaced apart by the central segment 262 and extend upward therefrom in parallel, so as to define the recess 261. In addition to preventing the panel 210 from bending, the lower cross-member 260 also functions to vertically support the panel 210 by spanning the distance between and being coupled to two posts 240. The lower cross member 260 may additionally include apertures (e.g., weep holes in the central segment 262; not shown) to facilitate draining of water that might otherwise collect in the recess 261 (e.g., that drips from surfaces of the panel 210 into the recess 261).

In fence systems 100 requiring greater height, multiple panels 210 may be stacked vertically. In such instances, one of the intermediate cross-members 270 is positioned vertically between two stacked panels 210. Each intermediate cross member 270 defines an upper recess 271A for receiving the lower end of one panel 210 and a lower recess 271B for receiving the upper end of another panel 210. Each intermediate cross-member 270 includes a central segment 272 (e.g., a web) and two outer segments 253 (e.g., flange, or leg) that are spaced apart by the central segment 272. The two outer segments 253 extend upward and downward therefrom in parallel to define the upper and lower recesses 271A, 271B on upper and lower sides of the central segment 272. In addition to preventing horizontal bending of the panels 210 thereabove and therebelow, the intermediate cross member 270 also functions to vertically support the panel 210 thereabove by spanning between and being coupled to two of the posts 240. The intermediate cross member 270 may additionally include weep holes (not shown) in the central segment 262 to facilitate draining of water that might otherwise collect in the upper recess 271A.

The posts 240 and cross-members 250, 260, 270 may, for example be made of extruded aluminum or other suitable material, which is colored (e.g., powder coated, anodized, etc.) to match, complement, or otherwise coordinate with a color of the decorative layer 27b of the panels 210.

To install the freestanding fence system 201, two of the posts 240 are embedded into the ground (e.g., with concrete, as described above) at a predetermined distance apart (e.g., with the center webs 242 being approximately eight feet apart) with one of the recesses 241 of each post 240 being aligned and oriented with each other. A lower structural member 260 is then inserted into the recesses 241 of the two posts 240, arranged in its desired height and orientation (e.g., horizontal), and then coupled to the two posts 240 with fasteners 280.

A first or lower panel 210 is then inserted into the recesses 241 of the two posts 241 and coupled thereto. More particularly, the lower panel 210 is raised above upper ends of the posts 240 and lowered into the recesses or channels 241 until resting on the lower structural member 260 in the recess 261. It should be noted that because the thickness of the panel 210 is less than the width of the recess 261 of the cross member 260 (i.e., for receipt therein), an even larger gap is formed between the recess 241 of the post 240 (i.e., being sufficient to receive the cross-members 250, 260, 270 therein) and the panel 210, which facilitates sliding down of the panel 210 to its resting position. The panel 210 is then coupled to the two posts 240 with fasteners 280 inserted into the channels 244. For example, a common fastener 280 may be used to couple the panel 210 and the cross member 260 to the post 240 (i.e., with a single fastener shaft extending through the outer segment 243 of the post 240, the outer segment 263 of the cross member 260, and into the panel 210. Such a fastener may also extend entirely through the panel 210 and opposite outer segment 263 of the cross member 260, and opposite outer segment 243 of the post 240 (e.g., to receive a nut thereon). When using a common fastener for coupling both the lower cross member 260 and the panel 210 to the post 240, the lower cross member 260 must be supported in its desired orientation and position until the lower cross member 260 and the panel 210 are simultaneously coupled to the post 240. Further fasteners may (e.g., at different vertical locations) may further couple the panel 210 to the posts 240. According to another alternative method, the lower panel 210 may be embedded into the ground, in which case the lower cross-member 260 may be omitted with the panel 210 being supported vertically by the ground and/or fasteners.

In applications using multiple stacked panels 210 (e.g., three stacked panels 210, as shown in FIG. 7), the intermediate cross-member 270 is inserted into the recesses 241 of the two posts 240, moved and oriented into position (i.e., with the upper end of the lower panel 210 being received in the lower recess 271B thereof), and coupled to the post 240 (e.g., with a fastener 280 extending through the outer segments 243 and/or 253 and into the panel 210). An intermediate or upper panel 210 is then inserted into the recesses 241 of the two posts 240, lowered into the upper recess 271 of the intermediate cross member 270, and coupled to the intermediate cross member 270 and/or posts 240 in the manner described above. Installation of further intermediate cross members 270 and stacked panels 210 is then repeated until a desired height is achieved.

After the uppermost panel 210 is installed, which may be the lower panel 210 (i.e., in installations being only one panel high), the upper cross-member 250 is then inserted into the recesses 241 of the two posts 240, is arranged in its desired position and orientation (e.g., horizontal, so as to receive an upper end of the uppermost panel 210 in the recess 251 thereof), and is coupled to the two posts 240 with fasteners extending through the outer segments 241 an/or 251 of the post 240 and upper cross member 250, respectively, and into the panel 210, in the manner described above.

This installation process described above is repeated for additional horizontal sections with adjacent fence sections using a common post 240. Depending on the application, the panels 210, posts 240, and/or cross members 250, 260, 270 may also be field cut to length and/or angle to achieve a desired size.

While the description is made in connection with certain embodiments, it is to be understood that the disclosure is directed to various modifications and equivalent arrangements included within the scope of the claims, which are to be accorded the broadest reasonable interpretation as is permitted under the law so as to encompass such modifications and equivalent arrangement.

As utilized herein, the terms “approximately,” “about,” “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, elements shown as integrally formed may be constructed of multiple parts or elements, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present disclosure.

What is claimed is:

1. A free-standing fence system comprising:
two or more posts; and
one or more substantially planar prefabricated panels coupleable to two of the posts to be supported thereby, each prefabricated panel comprising:
a foam core having a first side and a second side, and
a first veneer layer coupled to and covering a substantial entirety of the first side of the foam core, wherein the veneer layer comprises one or more veneer members, each veneer member having a decorative layer of a continuous natural stone material, and a binding layer coupled to a rear surface of the decorative layer.

2. The free-standing fence system according to claim 1, wherein the binding layer is layer of epoxy continuously adhered to the decorative layer.

3. The free-standing fence system according to claim 2, wherein the epoxy is impregnated into the natural stone material of the decorative layer.

4. The free-standing fence system according to claim 2, wherein the epoxy of the binding layer is continuously adhered to the first side of the foam core with an intermediate adhesive.

5. The free-standing fence system according to claim 2, wherein each prefabricated panel further comprises a base layer cured to the first side of the foam core, and the epoxy of the binding layer is continuously adhered to the base layer with an intermediate adhesive.

6. The free-standing fence system according to claim 2, wherein a second veneer layer is coupled to and substantially covers a substantial entirety the second side of the foam core, wherein the second veneer layer comprises one or more of the veneer members.

7. The free-standing fence system according to claim 6, wherein the epoxy of the binding layer of the one or more veneer members of the first veneer layer is continuously adhered to the first side of the foam core with an intermediate adhesive, and the epoxy of the binding layer of the one or more veneer members of the second veneer layer is continuously adhered to the second side of the foam core with the intermediate adhesive.

8. The free-standing fence system according to claim 7, wherein the adhesive is one of a curable adhesive or a tape adhesive.

9. The free-standing fence system according to claim 8, wherein the veneer members are resiliently flexible.

10. The free-standing fence system according to claim 1, wherein each veneer assembly includes a backing layer coupled to and substantially covering the binding layer of each veneer member, the backing layer being coupled to the first side of the foam core, so as to couple each veneer member to the foam core.

11. The free-standing fence system according to claim 10, wherein each veneer assembly includes a plurality of veneer members, and the backing layer couples each veneer member to maintain the veneer members in a predetermined relationship.

12. The free-standing fence system according to claim 1, wherein the core has a first thickness and the decorative layer has a second thickness that is approximately 5% or less of the first thickness.

13. The free-standing fence system according to claim 1, wherein each panel includes an upper structural member coupled to a top of the core and extending a width of the core, and includes a lower structural member coupled to a bottom of the core and extending the width of the core, wherein the upper structural member and the lower structural member are continuous members each have a constant cross section with one or more central segments extending from a lateral segment into an interior of the core.

14. The free-standing fence system according to claim 13, wherein each post is a continuous member having a constant cross section with a central segment and two lateral segments, each extending laterally in opposite directions from the central segment, and each panel is configured to couple one of the lateral segments with a fastener received through one of the central segments of each of the upper structural member and the lower structural member.

15. The free-standing fence system according to claim 1, further comprising a lower cross member and an upper cross member, wherein the lower cross member is coupleable to two of the posts to support one of the panels thereabove and includes an upper recess for receiving a lower end of the panel therein, and the upper cross member is coupleable to the two posts and includes a lower recess for receiving an upper end of one of the panels therein.

16. The free-standing fence system according to claim 15, comprising at least two panels and further comprising an intermediate cross member coupleable to the two posts to support one of the two panels thereabove, wherein the intermediate cross member includes an upper recess for receiving therein a lower end of the panel to be positioned thereabove, and includes a lower recess for receiving therein an upper end of the other of the two panels.

17. A modular fence panel for a free-standing fence system comprising:
a foam core having a first side and a second side, and a first thickness extending between the first side and the second side;
a first veneer layer coupled to and covering a substantial entirety the first side of the foam core, wherein the first veneer layer comprises one or more veneer members, each veneer member having a decorative layer of a continuous natural stone material that has a second thickness that is approximately 5% or less of the first thickness; and
a second veneer layer coupled to and covering a substantial entirety second side of the foam core, wherein the second veneer layer comprises one or more of the veneer members;
wherein each modular fence panel is substantially planar.

18. The modular fence panel according to claim 17, wherein each veneer member includes a binding layer of epoxy continuously adhered to the decorative layer, the binding layer of the one or more veneer members of the first veneer layer is continuously adhered to the first side of the foam core with an intermediate adhesive selected from the group consisting of curable adhesives and tape adhesives, and the epoxy of the binding layer of the one or more veneer members of the second veneer layer is continuously adhered to the second side of the foam core with the intermediate adhesive.

19. The modular fence panel according to claim 17, further comprising a first base layer cured to the first side of the foam core and a second base layer cured to the second side of the foam core, and wherein each veneer member includes a binding layer of epoxy continuously adhered to the decorative layer; and
wherein the epoxy of the binding layer of the one or more veneer members of the first veneer layer is continuously adhered to the first base layer with an intermediate adhesive selected from the group consisting of curable adhesives and tape adhesives, and the epoxy of the binding layer of the one or more veneer members of the second veneer layer is continuously adhered to the second base layer with the intermediate adhesive.

20. A method of manufacturing a modular fence panel comprising:
providing a foam core having a first side and a second side, the first side and the second side being substantially planar;
providing a plurality of veneer assemblies, wherein veneer assembly comprises a decorative layer of a natural stone material and a binding layer of epoxy continuously adhered to a rear surface of the natural stone material, each veneer assembly being resiliently flexibly; and
coupling one or more of the veneers assemblies to substantially cover the first side and the second side of the foam core in their entirety with an adhesive substantially covering the binding layer.
